(19) United States
(12) Patent Application Publication
(10) Pub. No.: US 2004/0041841 A1
(43) Pub. Date: Mar. 4, 2004

(54) Enhanced contact navigator with interactive tabs for managing network events in real time

(76) Inventors: Stephane LeMogne, Brest Cedex (FR); Musa J. Hanhan, Burlingame, CA (US); Laura Jean Haggerty, San Francisco, CA (US); Boris Nicholas, Brest Cedex (FR); Cecile Bonnaud, Brest Cedex (FR)

Correspondence Address: CENTRAL COAST PATENT AGENCY, PO BOX 187, AROMAS, CA, 95004, US

(21) Appl. No.: 10/350,995

(22) Filed: Jan. 23, 2003

Related U.S. Application Data
(60) Provisional application No. 60/406,437, filed on Aug. 27, 2002.

(51) Int. Cl. G09G 5/00

(52) U.S. Cl. 345/777; 345/736; 345/738

(57) ABSTRACT

An interactive information display for a communication terminal includes a tab navigation region; one or more interactive tabs, each tab associated with an active or passive communication event at the communication terminal, and a plurality of interactive icons associated with specific tabs. The interactive icons are individually enabled in the tabs for each communication event that goes active and are individually disabled or terminated as each communication event is completed, and wherein interaction with one or more icons, some of which are dynamically generated alert icons associated with a tab, causes relevant data to be retrieved from at least one data source and displayed in one or more windows associated with the relevant tab.

### CROSS-REFERENCE TO RELATED DOCUMENTS

The present invention claims priority to U.S. provisional patent application “Enhanced Contact Navigator With Interactive Tabs for Managing Network Events in Real Time”, bearing S/No. 60/406,437, and filed on Aug. 27, 2002.

### FIELD OF THE INVENTION

The present invention is in the area of interactive user interfaces on displays of computerized workstations and remote hand-held devices, and pertains more particularly to special features enhancing real-time management of network events and disparate applications displayed in the interface.

### BACKGROUND OF THE INVENTION

One of the biggest problems today in visually presenting data about multiple topics on an information communication device, such as, for example, a computerized workstation with a video display unit, the computer connected to a data communication network, is in making available in real time a very large amount of information that a user needs, particularly as that information may be constantly changing, requiring nearly continuous updating. This problem is particularly acute in presenting data used by agents in customer relations centers, which is a primary focus of embodiments of the present invention, but it also occurs in many other types of data presentation as well.

In the current art of information presentation, at any given time, only a fraction of or a certain defined aspect of the entire amount of a large store of information can be viewed. For example, in a word processing document, only a page or a part of a page can be viewed at one time with any degree of legibility. In spread sheets, usually only one sheet or a portion of one sheet can be viewed at one time; and likewise, in large relational databases, only certain portions can be usefully reviewed at any given time.

In the context of agents dealing directly with customers and clients, involving customer-relations management, the real-time aspect of information availability is very important, because an agent must very often deal with multiple communicants (customers, clients) more or less simultaneously, and the agent therefore needs to have all the information about all communications immediately available. However, partly because often multiple modes of real time communication are involved, such as chat, chat relay, message relay, instant messaging, email, etc., in addition to conventional and IPNT phone calls, simultaneous or near simultaneous and ongoing changes to multiple datum must be made available to the agent in real time, or near real time.

Up until the present invention a common approach in making large quantities of information available in a user interface of a data communication device is by dividing up the information, usually by some type of topical sorting system, and presenting the topics on multiple tabs.

FIG. 1 shows an example of a scheme of tabular sorting and presentation of information in the prior art, taken from the application Microsoft Outlook™. In this example of an interactive interface, a window 100 comprises a tab region 101, which, in this example, has nine tabs in two rows. When a user selects a tab, such as the Preferences tab as shown in this example, the selection opens an activity region 102 that can (and does in this example) contain multiple fields. By selection and manipulation of these fields a user can view information, take actions, and make changes, using function and command tools such as button 106 and input field 105.

FIG. 2 illustrates another example of tabular sorting and presentation of information, in this case, from the Palm™ Desktop™ application. Window 200 has a tab region 201 which is, in this example, displayed vertically to the left of activity region 202. Region 202 contains multiple fields that either show information, such as date information areas 208, 207, and 206; or allow data input, such as in the area 205, where the user can input contact address information.

If changes were to occur to data associated with this display while a user is not viewing the display activated by the associated tab, such as, for example, in FIG. 2, changes to the “To Do” schedule (not current in FIG. 2) while the user is viewing information in the Date tab (current in FIG. 2), those changes would not be visible to the user without the user selecting that tab, which normally the user would not have any reason or indication to do.

What is clearly needed are special features enhancing real-time management of network events and disparate applications displayed in the interface. Such features would enhance the efficiency of the display operator and provide notification to otherwise undetectable updates.

### SUMMARY OF THE INVENTION

In a preferred embodiment of the invention an interactive information display for a communication terminal is provided, comprising a tab navigation region, one or more interactive tabs, each tab associated with an active or passive communication event at the communication terminal, and a plurality of interactive icons associated with specific tabs. The icons are individually enabled in the tab for each communication event that goes active and are individually disabled or terminated as each communication event is completed, and wherein interaction with one or more icons, some of which are dynamically generated alert icons associated with a tab, causes relevant data to be retrieved from at least one data source and displayed in one or more windows associated with the relevant tab.

In a preferred embodiment the additional data includes state and performance data. Also in a preferred embodiment the communication terminal is one of a desktop computer, a laptop computer, a PDA, or a cellular telephone with a display screen. The display may part of a browser interface.

In another embodiment of the invention the tabs, icons and associated data resulting in interaction with icons are delivered as Java Server Pages using Java Script technology. In yet another embodiment, tabs, icons, and associated data resulting in interaction with icons are delivered as Java Applets.

In some cases the alert icons appear as notifications of events occurred in the system, the events related to a particular tab. Also in some cases the interactive icons can be activated by one or a combination of mouse over, keyboard stroke and mouse click. In yet other cases the one or more windows are spawned as a result of interacting with an interactive icon, the windows interactive by mouse over, keystroke, or mouse click to provide more granular data with each subsequent interaction after an initial interaction.

In yet other embodiments the relevant data retrieved as a result of icon interaction is authentication data. In still other embodiments individual ones of the interactive icons appear automatically at the conclusion of a client task performed independently of the interface.

In another aspect of the invention a software/hardware system-architecture for dynamically updating an interactive information display for a communication terminal with relevant data, the display including a tab navigation region, a plurality of interactive tabs associated with active or passive communication events, and a plurality of interactive icons associated with specific ones of the interactive tabs is provided, comprising a client application hosting the interactive information display, the client application hosted on the communication terminal, a server application for retrieving the relevant data and serving the relevant data to the client application, the server application hosted on an intermediate server, at least one data source for storing the relevant data, and a data-packet-network connecting the communication terminal, the server and the at least one data source. The system-architecture is characterized in that requests initiated at the communication terminal by way of manipulating a tab or icon of the interactive display are sent over the data packet network to the server application whereupon the server application obtains data relevant to the request and dynamically updates the information display with the retrieved data. In a preferred embodiment the data-packet-network includes a local-area-network connected to the Internet network and the communication terminal is hosted on the Internet. Also in a preferred embodiment the communication terminal is one of a desktop computer, a laptop computer, a PDA, or a cellular telephone with a display screen. The at least one data source may hold current state information and performance data. Also, the display may be part of a browser interface.

In some cases the server application includes a controller containing an action Servelet module and a dynamic Action Class definition module for mapping to an identified data source and data type stored in the data source. The data source may be a relational data source and is accessed through an object-oriented framework. Further, dynamic updates may be presented in Java Sever Pages.

In still other embodiments individual ones of the interactive icons appear automatically at the conclusion of a client task performed independently of the information display, the task conclusion registered by the system as an event. In yet other embodiments the relevant data retrieved as a result of icon interaction is user authentication data. Still further, passive interactive icons not yet terminated may be re-activated by automatic appearance of an alert icon.

In yet another aspect of the invention a method for providing real time update data to a communication terminal hosting an information display, the display including a tab navigation region, a plurality of interactive tabs associated with active or passive communication events, and a plurality of interactive icons associated with specific ones of the interactive tabs is provided, comprising steps of (a) interacting with an interactive icon associated with an interactive tab; (b) sending the results of interaction to an intermediate server application in the form of a request; (c) searching for the relevant data identified in the request; (d) retrieving the searched data; (e) generating a dynamic view including the update data; and (f) sending the dynamic view to the communication terminal to replace the current view.

In a preferred embodiment of the method, in step (a), the interactive icon is a knowledgebase icon for retrieving knowledgebase data. Also in a preferred embodiment, in step (a), the interactive icon is an automated alert icon that appears in the interactive tab as a system generated alert. In still another embodiment, in step (f), the view is a Java Server Page generated and served to the information display by the server application.

### BRIEF DESCRIPTION OF THE DRAWING FIGURES

FIG. 1 is an example of tab-activated information selection and management in the prior art.

FIG. 2 is another example of tab-activated information selection and management in the prior art.

FIG. 3 is an illustration of an interactive display window in an embodiment of the present invention.

FIG. 4 illustrates an interactive display window in an actual implementation (embodiment) of the invention, meant for management of information by communication agents.

FIG. 5 illustrates navigation features in an embodiment of the present invention.

FIG. 6 is a block diagram illustrating application deployment architecture according to an embodiment in the present invention.

FIG. 7 is a block diagram illustrating the relationship between software clients.

FIG. 8A is a block diagram illustrating a software stack traditional for a fat client according to prior art.

FIG. 8B is a block diagram illustrating a software stack for implementing a thin client according to an embodiment of the present invention.

FIG. 9 is a block diagram illustrating interactive enhancements to the interactive display window of FIG. 3.

FIG. 10 is a block diagram illustrating various components and thin-client software structure according to an embodiment of the invention.

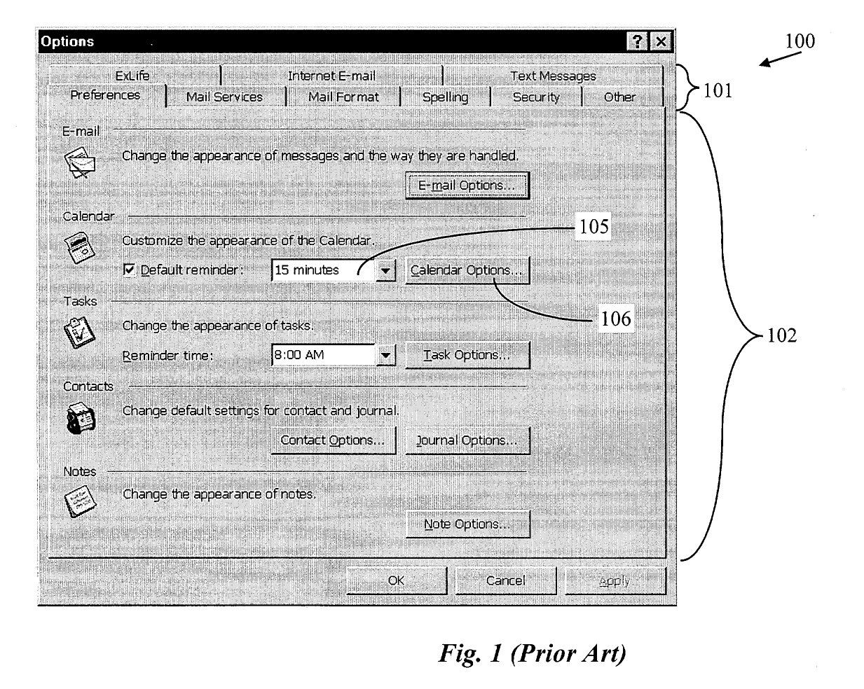

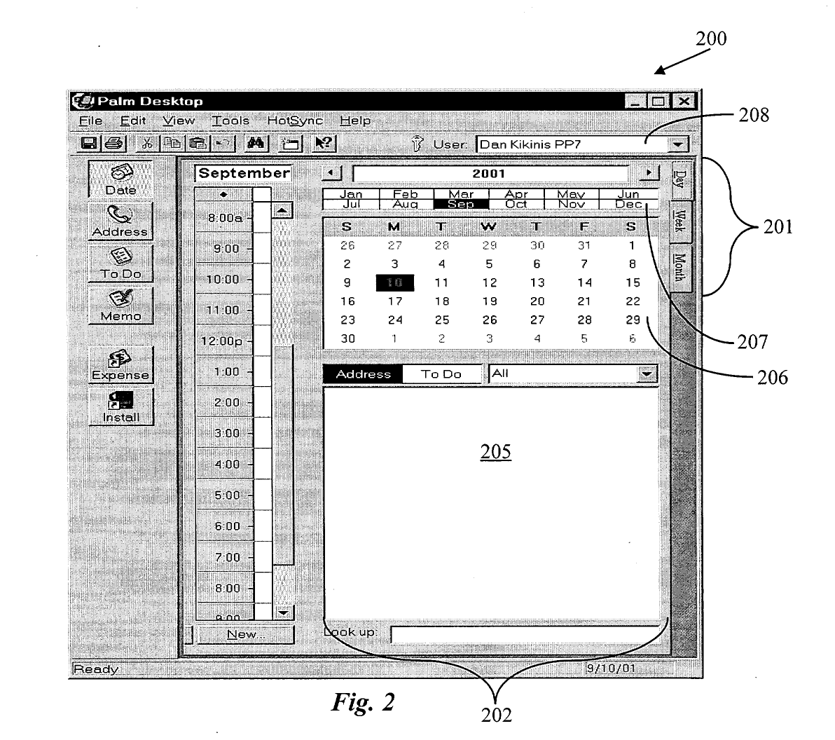

### DESCRIPTION OF THE PREFERRED EMBODIMENTS

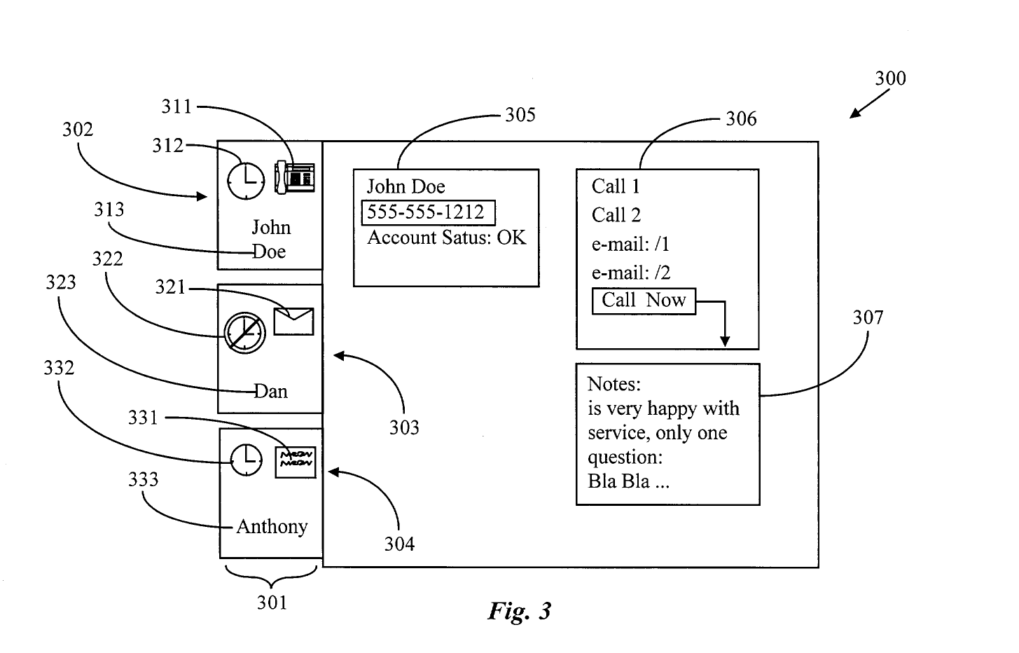

FIG. 3 is a generalized overview of a window 300, illustrating an embodiment of the present invention. In this example an interface for tracking customer communications on a computer screen of a workstation manned by a customer relations agent is illustrated. An active region, termed by the inventors a tab navigation region 301, contains in this example, three tabs, each of which contain in this example two icons: one for connection method (communication medium used) and one for time considerations; plus as a third item, the name of the caller or communicant.

For example, in tab 302, name 113 of the first caller or communicant is John Doe. He is connected by telephone, as shown by icon 311 as a simple telephone icon, and it's a time sensitive connection, as indicated by icon 312 in the form of a clock face.

In a second tab 303 the name 323 of a second communicant is Dan. He has sent an e-mail, represented by icon 321 indicating a letter. Icon 322 as a clock is overlaid by the international “not” symbol of a diagonal red stripe in a circle, indicating that the call is not time-sensitive.

Additional windows 305, 306, and 307 offer interaction and other relevant information for the customer service representative about individual ones of the communication events associated with a tab in the tab region, and each of these windows for expanded information is invoked, in this example, by a clicking action on the appropriate tab with a mouse or other pointer device by the agent. Windows may also be closed again by an appropriate action, such as a close button or a double-click, for example.

The third tab 304 indicates, by an icon 331, a chat session with Anthony (name 333). Icon 332 indicates that this communication event is time sensitive, as for tab 302. In a further enhancement, for any arriving dialog event from Anthony in the chat session, icon 331 changes color from red to green, indicating an incoming chat message has arrived. Alternatively the icon might flash or blink, for example, as an alert to the agent.

In some embodiments further information about an enabled communication event may be provided in a tab. The clock face symbol, described above for time sensitivity, for example, may be updated to indicate time from establishing of a live call, or time since an e-mail was received, and so forth.

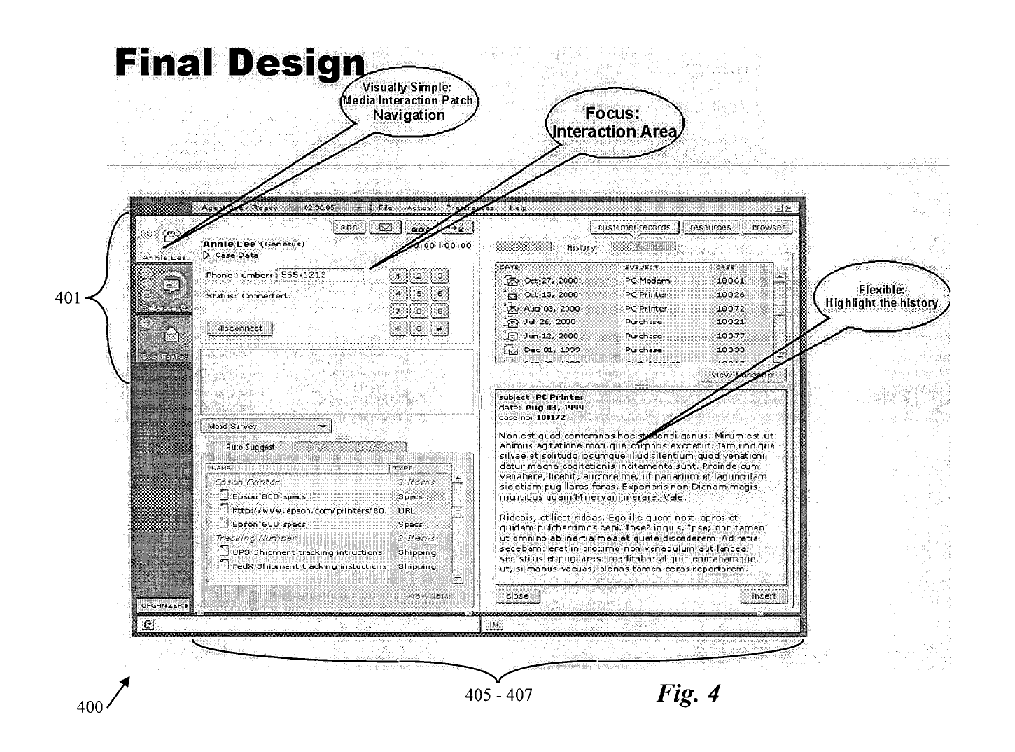

FIG. 4 is an actual interactive window 400 of an agent desktop active interface in an embodiment of the invention, which is quite similar to the more generalized example illustrated by FIG. 3. Again, there is an active tab region 401 in window 400 and work areas 405 through 407, with various highlights, and so forth.

There are a number of ways that tabs may be implemented in embodiments of the invention. In one embodiment tab icons may automatically appear as active communication events are established or enabled, and disappear as such events are terminated or disabled. In another, there may be a pool of generic icon types, and an agent may enable numbers of one or more types to appear in the tab region. Then, as events are enabled and disabled, new events take the next available proper icon type. Icons remain in the tab region, but identification and update only take place for those that are active and associated with an event.

In some embodiments it may be necessary for an agent to perform some finalization tasks to retire an icon, such as indicating whether or not to save, how, and with what priority. There can also be an active button on a tab region

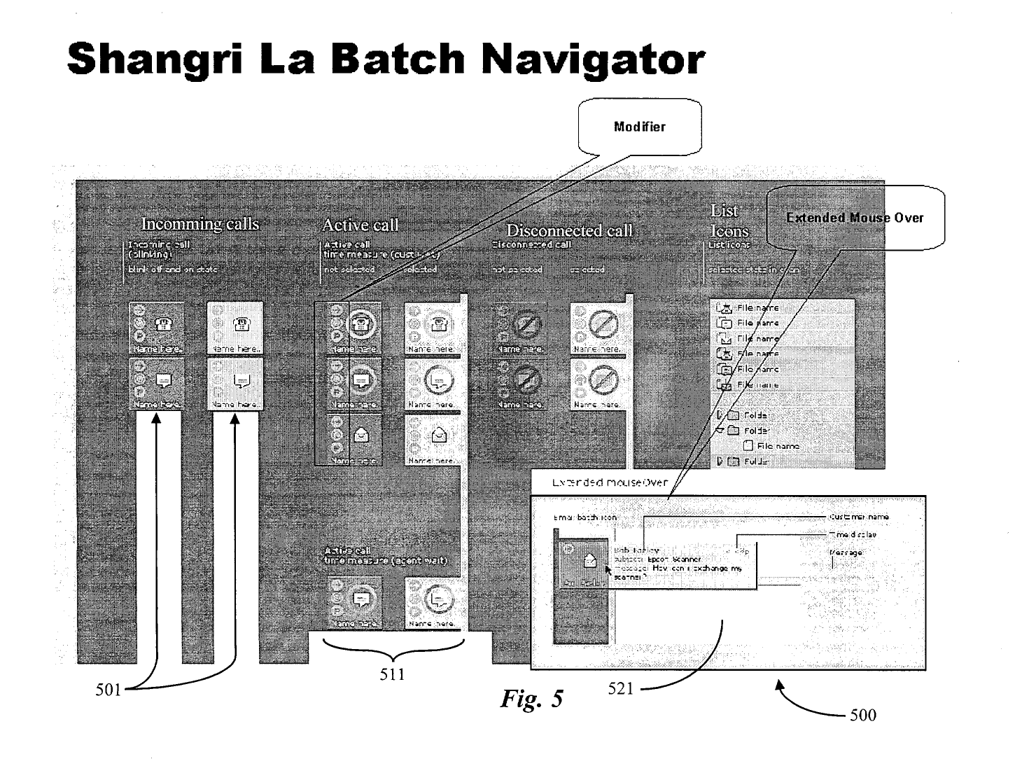

FIG. 5 illustrates a batch navigator, where multiple different activities, such as incoming calls, active calls, disconnected calls, and so on, are shown in three different batches. It will be apparent to the skilled artisan, given the teaching herein, that there may be more than three batches, and events may be associated in batches in different ways.

By interfacing to icons in the batches by mouse-over, in this example, information such as, for example, an extension, can be popped up, as shown in insert 521. In this example the agent has done an extended mouse-over of an e-mail icon, shown at the left in widow 521, with the name of Bob Farley, the e-mail letter icon, and a not-time-sensitive icon, as previously shown and described for active tab regions. Window 521 also provides additional information, such as Subject: “Epson Scanner”, message: “How can I exchange my scanner?” and a time display. In this case all of the information can be made available without requiring the user to click on an area or to change tabs.

Once a tab is clicked on, the appropriate window opens to its work areas, in the manner previously described with reference to FIG. 3. Additional information and disclosure is provided for embodiments of the present invention in a presentation entitled “Shangri-La” appended to this specification as Appendix I. It will be apparent to the skilled artisan that embodiments described and illustrated in the overall disclosure presented can be altered in many ways without departing from the spirit and scope of the invention. The structure of the tabs can vary considerably, for example, and the look and feel of the unique navigation technique can vary as well.

Architecture

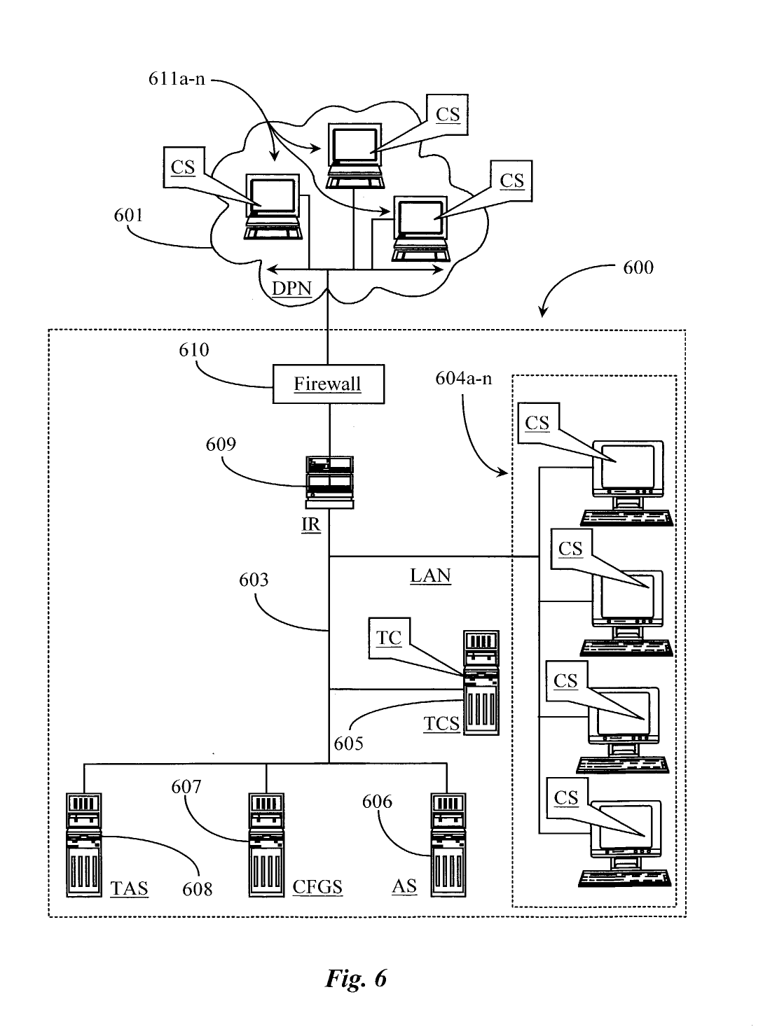

FIG. 6 is a block diagram illustrating application deployment architecture according to an embodiment in the present invention. It was described above that there are many different data presentation environments that are applicable to the methods and apparatus of the invention. However, in one preferred embodiment, the invention is practiced in a communication center environment.

A communication center 600 is illustrated herein as the host of the software function of the present invention. Center 600 is, in this particular example, an IP-capable center. Center 600 may also practice traditional connection-oriented-switched-telephony (COST) although no COST equipment is illustrated. COST equipment would include implements such as internal telephony wiring, a central telephony switch and a computer telephony integration (CTI) processor.

Center 600 has a pool of center agents working in individual agent stations 604a-n. Each agent station is LAN-connected to a LAN 603 deployed strategically within center 600. In one embodiment, LAN 603 is TCP/IP enabled as well as enabled with other Internet protocol to achieve an extension network to the Internet. The Internet is represented by a cloud 601 labeled DPN (data-packet-network) in this case. The inventors consider the well-known Internet network as a preferred main network because of its high public-access characteristic and because essentially there are no geographical limitations to the practice of the invention over the Internet. In other embodiments, DPN 601 may be a public or private WAN, an Ethernet, or an Intranet network, or even a combination of the above.

Network 601 has a backbone (double arrow) represented therein to which a plurality of clients 611a-n have connection. Such connection may be wireless or wired network connection means including dial-up through an ISP. Clients 611a-n may be clients of center 600, remote agents associated with center 600 or a combination thereof. Likewise, clients may have access to center 600 through a variety of network-capable communication devices such as IP telephones, Cellular telephones, traditional computers both wired and wireless-access, or other capable devices.

Center 600 extends services to clients 611a-n through a security firewall 610 as is common in the art. Firewall 610 may be an external physical firewall or a software version. It is noted that other security regimens may also apply in combination with or in place of firewall 610 such as virtual private networks (VPNs) employing HTTPS protocol. Center 600 has a router (IR) 609 connected in line between other center equipment and stations and firewall 610. IR 609 for purpose of example may be assumed to represent all routing duties associated with supported media of center 600. The term router is defined broadly herein as any routing point for any media type or combination thereof supported within center 600. Examples include e-mail router, IP telephone router, telephony switch, chat server, and so on.

LAN 603 provides network connectivity for a plurality of communication center servers. For example, an application server (AS) 606 is provided for serving application functionality at the corporate level, which may be local, or in some cases remote and or distributed. A configuration server (CFGS) 607 is provided for enabling system updates and configuration. A transaction server (TAS) 608 is provided for individual transaction routing management according to prevailing interaction management routines and protocols.

A thin-client server (TCS) 605 is provided with LAN accessibility and is adapted to serve as a proxy between client software instances (CS) and high-level servers. Server 605 hosts a thin client (TC) software instance to reduce server response time and to improve efficiency of software function. It is noted herein that data must be obtained in real, or at least near real time and that part of the thin client is implemented at instances of CS as a graphical user interface (GUI). CS instances are distributed in this example to stations 604a-n (agent desktop applications) and to stations 611a-n (customer interface application). It is noted herein that customers of center 600 may obtain functionality through plug-in (CS instance) to existing browser applications, or may obtain functionality through an interfacing contact server (not shown) within domain 601.

Agent stations 604a-n all have instances of CS (interactive desktop applications). Server 605 functioning as a proxy runs an instance of thin client (TC). Server 605 has access to all other LAN connected resources such as TAS 608, CFGS 607, AS 606, and other data resources (not shown) that may be assumed to be present such as, perhaps a product knowledge base and a customer information system as well as a contact history database.

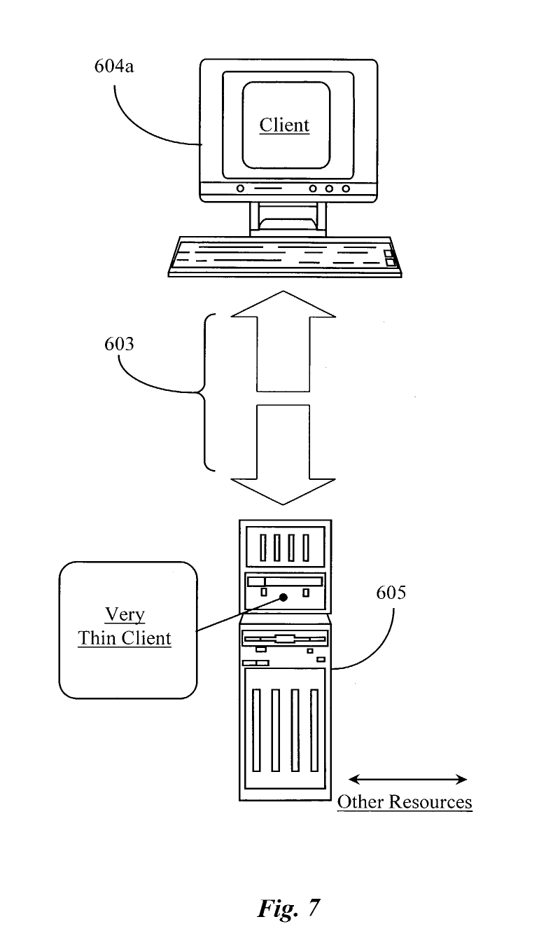

FIG. 7 is a block diagram illustrating the relationship between software clients of server 605 and agent station 604a. In this example, client machine 604a runs Client instance (CS) and server 605 runs a thin client TC instance of server software as was described above. LAN 603 is represented in this example as bi-directional. As an agent works at station 604a, all of his or her incoming events appear with the aid of client software as real time tab regions with icons as earlier described. In a preferred embodiment a client instance running on station 604a inter-operates with a browser application. In one embodiment the client navigator is a standalone client. The preference for browser integration will be described later in the specification.

Server 605 functions as a proxy server in this embodiment. Server 605 polls other resources for the data required to fill client instance at station 604a with pertinent data. There are a variety of different ways to partition the software of the present invention between client station 604a and server 605. A primary goal in this endeavor is to move toward a very thin client model in server 605, and in the client instance, which is browser software in a preferred embodiment. This can be partially accomplished by using protocols for interface such as hypertext markup language (HTML) and dynamic hypertext markup language (DHTML). In some browser-based embodiments Java or Java extensions are used to bind in other applications to the client.

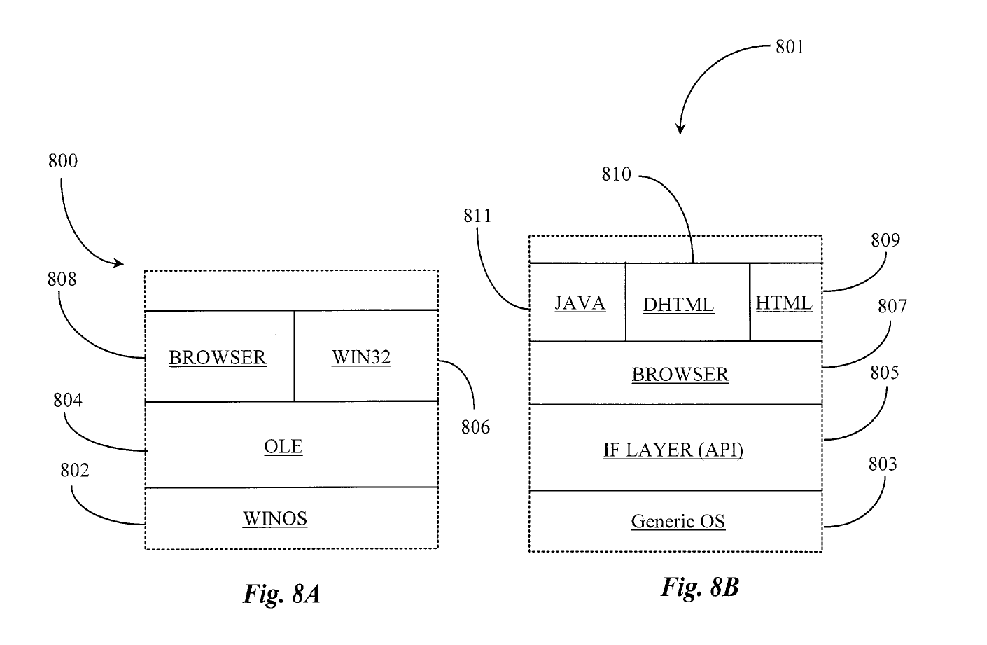

FIG. 8A is a block diagram illustrating a software stack 800 traditional for a fat client implementation according to prior art. A goal of the present invention is to thin the client server software described above as the instance residing in server 605 of FIGS. 6 and 7. Stack 800 is a traditional server stack for a WIN operating system. On top of the operating system 802 (WINOS), are applications using object linking and embedding technologies (OLE) layer 804. In response to an event, perhaps a request for data, a WIN32 operation 806 is called and executed and subsequently a browser 808 is launched and used for the purpose of accessing data through a Web interface.

FIG. 8B is a block diagram illustrating a software stack 801 for implementing a thin client according to an embodiment of the present invention. In this example, the application of the present invention can run on virtually any operating system 803, described herein as generic including the well-known WinOS, Linux, Unix, Solaris and so on. An interface layer (IF) or (API) 805 is provided to run on top of the operating system. IF layer 805 can be OLE, openacces or other like software but may also be a proprietary, embedded system, such as might be used with Linux or some other Unix-based system.

A browser or navigation layer 807 is provided and forms a common platform supporting application operation in encoded FITML 809 as an option. A DHTML extension 810 may be provided and utilized as well by parts of the application. Operational integration with and data access to other servers or resources can be performed through browser layer 807 using Java technology 811, including the use of beans or servelets. Other similar Web-based programming functional languages may be utilized as well. Information from the system framework and business logic, often processed for results can be pulled from a request or pushed in the form of an alert. The GUI as depicted in FIG. 3 of this specification can take the form of several media and function specific windows such as an e-mail manager, a voice manager, a chat manager, a contact manager, and so on. New function can be added with new media types. There are many possibilities.

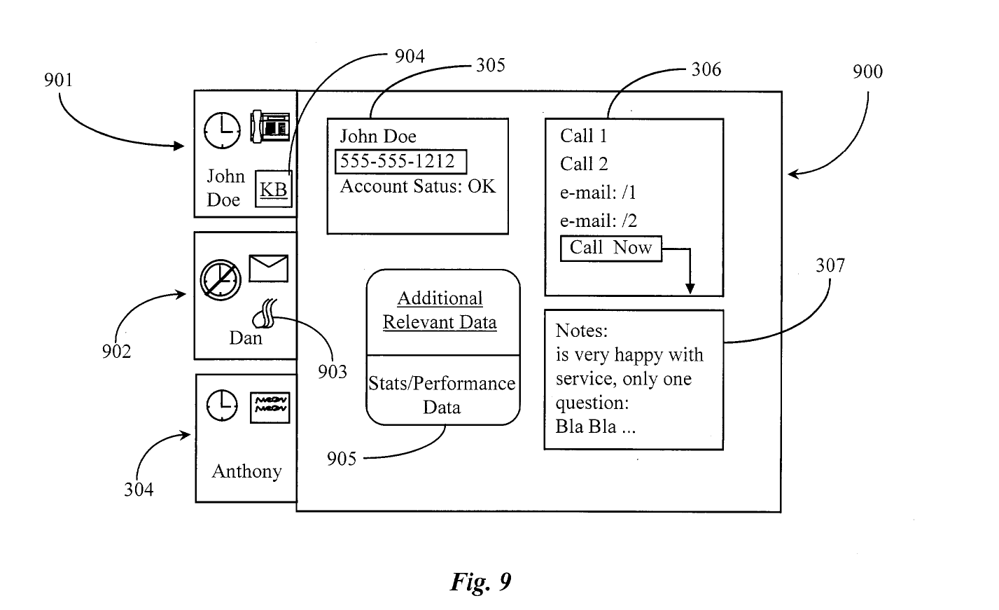

FIG. 9 is a block diagram illustrating interactive enhancements to the interactive display window of FIG. 3. Elements of this example that are not enhanced over the example of FIG. 3 above retain their original element numbers from FIG. 3, which in the case of some elements have been omitted from this example for clarity in illustration. Elements that are modified due to enhancement described in this example are given new element numbers and are introduced as new elements.

GUI window 900 has an elevated dimension of functionality over that of window 300 described with reference to FIG. 3. The new functionality is made possible in part by Java Server Pages (JSPs) presented to GUI 900 using Pushlet technologies in the form of interactive alert icons. To receive DPN events for interaction with the client software of the invention in a browser application (preferred) two methods can be used, one of which is Java Script (supported by most browsers).

In the case of Java Script the event flow sent to the GUI client is a JavaScript code generated on an event server (part of server 605). There are basically two embodiments pull method and push method. In the pull method, the browser calls a web page on the Web Server to receive events in JavaScript. The browser can also call a Web page where an event is sent in JavaScript by a real-time module. After the browser accounts for the event, the Web Page at the server side is reloaded to receive the next events.

In a push model, the client browser calls a Web page without pause to receive events sent in by a real-time module.

Java Applet:

In the case of Java Applet event flow comprises serialized objects. Using Java applets both pulling and pushing methods are possible. GUI 900 has a voice tab 901, an e-mail tab 902, and the formerly described chat session tab 304 described with reference to FIG. 3. Both tabs 901 and 902 are enhanced from their counterparts of the previous example (FIG. 3). For example, tab 902 has an interactive icon 903 that functions as an alert to the user. In this case the alert icon is a fire symbol signifying, for example, that there is some problem that demands immediate attention. An example could be that client “Dan” is a VIP client of significant value to the center's business. Assume that e-mail tab 902 has now progressed to a voice event similar to tab 901. If an agent after picking up the event then put Dan on hold to wait for another agent or supervisor, but the target individual has not responded, Dan's wait in queue may have exceeded a period of time deemed a reasonable wait time for VIP customers. In this case, after the time has elapsed, icon 903 (fire icon) suddenly appears in Dan's tab. It is noted that for voice, the telephone icon would also appear in place of the e-mail icon in a truly dynamic embodiment.

The visual graphic of fire icon 903 may be a moving brightly-colored flame designed to cause the agent to notice. The agent in response can click on icon 903 re-activating the connection with Dan, apologize for the extended wait and offer another solution such as a promise to call back so Dan does not have to wait any further. Icon 903 may take other eye-catching forms and may also be programmed for sound. Other definable trouble areas that sometimes occur in any communication center can be configured with thresholds and assigned alert style icons that appear in an appropriate tab or even in a common tool bar when the condition is prevalent. Another example would be that of a voice queue event threshold. If the agent's queue becomes too full, then an icon may appear in a neutral area of GUI 900 alerting the agent to route further events to a back-up agent if one exists.

GUI tab 901 has an added functional icon 904, which is a link to a knowledge base (KB) of data related to product and or customer history with that product, which may include pertinent customer-management performance history statistics related to John Doe's previous interaction history with center 600.

KB icon 904 is an interactive icon that may be partially activated for summary information by a mouse-over or may be fully activated by mouse click or assigned keyboard stroke. Interaction with icon 904 causes a window 905 to appear along with formerly described windows 305, 306, and 307. In this case, KB icon 904 can be persistent in all voice tabs or in all tabs for that matter. KB 904 is activated at the discretion of the agent and could be activated to retrieve data during an interaction or to add data to the knowledge base. In one embodiment, window 905 appears regardless of interaction with KB 904 but only holds summary data. In this case repeated clicking of icon 904 could cause subsequent data types to display in window 905 or more granular data to be displayed with every click. Window 905 may be formatted according to need. In this example, additional relevant data not presented in windows 305, 306, or 307 is displayed on top and communication-center performance data related to John is presented below. Performance data could also include real time QoS data over the instant connection channel.

In one embodiment, window 905 could be reserved for third party use such as for providing authentication information or security clearance. There are a number of possible configurations for window 905. In another embodiment, data in window 905 may be provided instead in a plurality of windows sorted by data type. Providing a KB icon specific to a client enables multiple database accesses without requiring multiple launches of a separate data base application. Likewise client specificity regarding window 905 ensures that the information requested can be associated to the correct client without error.

Other examples of real-time alert functionality might include a client transferred to a broker to make a specific transaction. When that transaction is complete, an icon indicating so may automatically appear on the client's tab. Upon notice thereof, the agent can re-activate the call for follow up and termination if the agent's services are no longer needed in that transaction. Yet another example would be that of an agent e-mailing a caller a form to fill out during a hold time in queue. Return of the form sent from the caller to the agent triggers an interactive icon indicating the completed form is there. Similar techniques can be applied to chat, instant messaging, file sharing, or co-browsing (follow me) sessions.

The method and apparatus of the invention is not limited to communication center application as other data presentation environments exist wherein the invention may be practiced. These include, but are not limited to internal process monitoring between machines, supply chain management systems, auto fleet management systems, and other like systems that can follow a model.

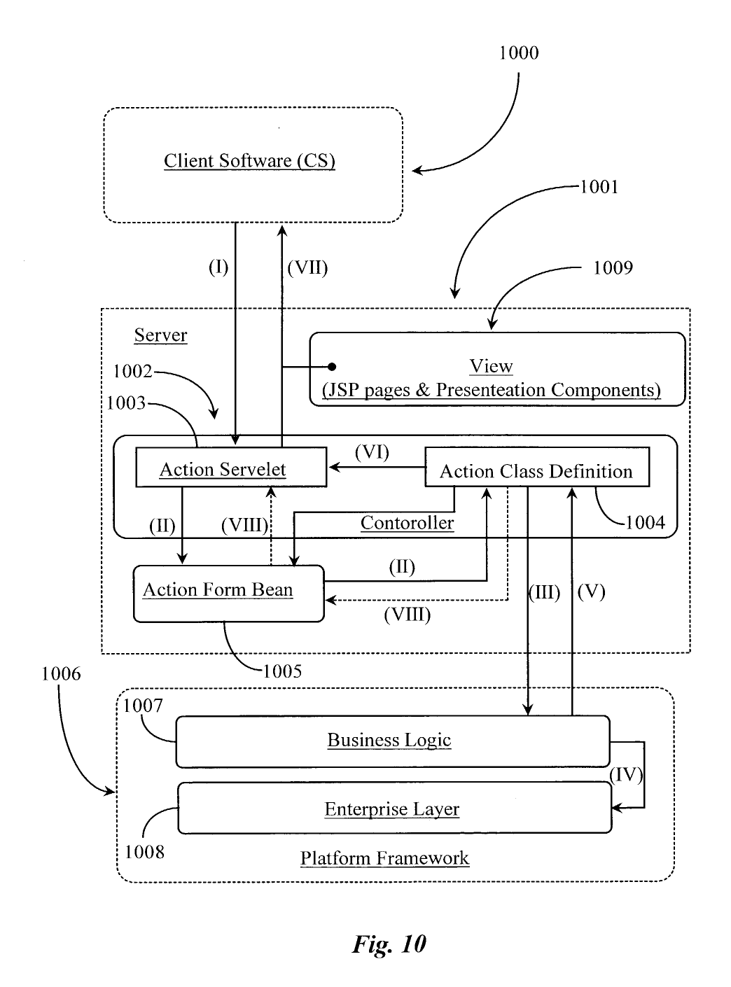

FIG. 10 is a block diagram illustrating various components and thin-client software structure according to an embodiment of the invention. A thin client model 1001 is achieved using Web-based Java technologies in a presentation layer to a GUI embedded in a client software (CS) 1000. Model 1001 is analogous to sever 605 of FIG. 6. Software 1000 is analogous to CS instances installed on stations 611a-n. The architecture follows a Struts architecture based on Java Servelet technology. A Java Servelet enables HTTP flow generation and the creation of a dynamic Web page.

A platform framework 1006 is object oriented and includes a business logic layer 1007 and an enterprise layer 1008. In this case, the framework is that of a telephony communication-center environment. Model 1001 includes a Java bean module or action form bean 1005 (optional) and a controller 1002. Controller 1002 contains an action Servelet (Java) 1003 and an action class definition 1004. The goal of the architecture is to present a dynamic JSP illustrated herein as JSP 1009. JSP 1009 is dynamically generated and is the current view presented to the GUI at client software 1000, preferably into a browser application that supports Java. In some embodiments (Java Script enabled) a standard browser application is all the software that is required to interoperate with the software on the server side.

In practice of the invention, a request is posted, for example, at an interfacing Web server or at server 1001 in step in (I). Server 1001 using the Java-based architecture (thin client) matches any request with the appropriate action class 1004 and bean 1005 if required. Action bean 1005 is used to receive the data identified in the request from the GUI at client software 1000. To determine an appropriate action to a posted request, data mapping is performed between action class 1004, bean 1005 and the posted request.

The mapping is performed by action servelet 1003 in (II). Servelet 1003 is at the center of the Stuts architecture. Mapping results of each posted request are specified in a single bitmap file. Action class definition 1004 is called and business logic 1007 within framework 1006 is accessed by Class 1004 in (III) when the mapping is complete. Business logic 1007 consults with enterprise layer 1008 in (IV).

Action class 1005 returns a status to the mapping dependant in (V and VI). JSP view 1009 is generated with the results of mapping. Action class 1004, if required, initializes bean 1005 with the returned value retrieved from business logic 1007 and it is sent to JSP 1009 via servelet 1003 to apply the most-current information in (VIII). Real-time data can, as a result, be delivered as a response to an initiated request, which may be manually or automatically initiated from the client side. In another embodiment JSP views are generated in a pull fashion enabling real-time alert icons to appear as previously described above. It is noted herein that the real-time data reported through the platform framework is, in one embodiment, stored in a relational database accessed through the platform framework.

It will be apparent to one with skill in the art that the method and apparatus of the invention can be applied to a wide variety of data presentation embodiments, many of which have been described. The claims should therefore be afforded the broadest interpretation under examination. The spirit and scope of the invention is limited only by the claims that follow.

What is claimed is:

1. An interactive information display for a communication terminal comprising:
a tab navigation region;
one or more interactive tabs, each tab associated with an active or passive communication event at the communication terminal; and
a plurality of interactive icons associated with specific tabs;
wherein the icons are individually enabled in the tab region for each communication event that goes active and are individually disabled or terminated as each communication event is completed, and wherein interaction with one or more icons, some of which are dynamically generated alert icons, associated with a tab causes relevant data to be retrieved from at least one data source and displayed in one or more windows associated with the relevant tab.

2. The display of claim 1 wherein the additional data includes state and performance data.

3. The display of claim 1 wherein the communication terminal is one of a desktop computer, a laptop computer, a PDA, or a cellular telephone with a display screen.

4. The display of claim 1 wherein the display is part of a browser interface.

5. The display of claim 1 wherein the tabs, icons and associated data resulting in interaction with icons are delivered as Java Server Pages using Java Script technology.

6. The display of claim 1 wherein the tabs, icons, and associated data resulting in interaction with icons are delivered as Java Applets.

7. The display of claim 1 wherein the alert icons appear as notifications of events occurred in the system, the events related to a particular tab.

8. The display of claim 1 wherein the interactive icons can be activated by one or a combination of mouse over, keyboard stroke and mouse click.

9. The display of claim 1 wherein the one or more windows are spawned as a result of interacting with an interactive icon, the windows interactive by mouse over, keystroke, or mouse click to provide more granular data with each subsequent interaction after an initial interaction.

10. The display of claim 1 wherein the relevant data retrieved as a result of icon interaction is authentication data.

11. The display of claim 1 wherein individual ones of the interactive icons appear automatically at the conclusion of a client task performed independently of the interface.

12. A software/hardware system-architecture for dynamically updating an interactive information display for a communication terminal with relevant data, the display including a tab navigation region, a plurality of interactive tabs associated with active or passive communication events, and a plurality of interactive icons associated with specific ones of the interactive tabs comprising:
a client application hosting the interactive information display, the client application hosted on the communication terminal;
a server application for retrieving the relevant data and serving the relevant data to the client application, the server application hosted on an intermediate server;
at least one data source for storing the relevant data; and
a data-packet-network connecting the communication terminal, the server and the at least one data source;
characterized in that requests initiated at the communication terminal by way of manipulating a tab or icon of the interactive display are sent over the data packet network to the server application whereupon the server application obtains data relevant to the request and dynamically updates the information display with the retrieved data.

13. The system-architecture of claim 1 wherein the data-packet-network includes a local-area-network connected to the Internet network and the communication terminal is hosted on the Internet.

14. The system-architecture of claim 1 wherein the communication terminal is one of a desktop computer, a laptop computer, a PDA, or a cellular telephone with a display screen.

15. The system-architecture of claim 1 wherein the at least one data source holds current state information and performance data.

16. The system-architecture of claim 1 wherein the display is part of a browser interface.

17. The system-architecture of claim 1 wherein the client application is a browser application.

18. The system-architecture of claim 1 wherein the server application includes a controller containing an action Servelet module and a dynamic Action Class definition module for mapping to an identified data source and data type stored in the data source.

19. The system-architecture of claim 1 wherein the data source is a relational data source and is accessed through an object-oriented framework.

20. The system-architecture of claim 1 wherein dynamic updates are presented in Java Sever Pages.

21. The system-architecture of claim 1 wherein individual ones of the interactive icons appear automatically at the conclusion of a client task performed independently of the information display, the task conclusion registered by the system as an event.

22. The system-architecture of claim 1 wherein the relevant data retrieved as a result of icon interaction is user authentication data.

23. The system-architecture of claim 1 wherein passive interactive icons not yet terminated are re-activated by automatic appearance of an alert icon.

24. A method for providing real time update data to a communication terminal hosting an information display, the display including a tab navigation region, a plurality of interactive tabs associated with active or passive communication events, and a plurality of interactive icons associated with specific ones of the interactive tabs comprising steps of:
(a) interacting with an interactive icon associated with an interactive tab;
(b) sending the results of interaction to an intermediate server application in the form of a request;
(c) searching for the relevant data identified in the request;
(d) retrieving the searched data;
(e) generating a dynamic view including the update data; and
(f) sending the dynamic view to the communication terminal to replace the current view.

25. The method of claim 24 wherein in step (a) the interactive icon is a knowledgebase icon for retrieving knowledgebase data.

26. The method of claim 24 wherein in step (a) the interactive icon is an automated alert icon that appears in the interactive tab as a system generated alert.

27. The method of claim 24 wherein in step (t) the view is a Java Server Page generated and served to the information display by the server application.
